(19) United States
(12) Patent Application Publication
(10) Pub. No.: US 2022/0081255 A1
(43) Pub. Date: Mar. 17, 2022

(54) Retrofit Voice Activated Elevator Control System

(71) Applicants: Stephen J. Gielarowski, Upper St. Clair, PA (US); Stephen J. Gielarowski, JR., Bridgeville, PA (US)

(72) Inventors: Stephen J. Gielarowski, Upper St. Clair, PA (US); Stephen J. Gielarowski, JR., Bridgeville, PA (US)

(21) Appl. No.: 17/386,130

(22) Filed: Jul. 27, 2021

Related U.S. Application Data
(60) Provisional application No. 63/056,780, filed on Jul. 27, 2020.

(51) Int. Cl. B66B 1/46; B66B 1/34; B66B 1/14

(52) U.S. Cl. CPC B66B 1/468; B66B 1/3492; B66B 2201/463; B66B 2201/4646; B66B 1/14

(57) ABSTRACT

Disclosed is a retrofit voice actuated system configured to be coupled to an existing system for controlling the movement of an elevator car between floors of a multi-floor structure. The existing system includes at least one hall push button on each floor accessible to the elevator car, a car operating panel in the elevator car including, for each floor, at least one car push button including a switching element associated with the push button, and an elevator control system responsive to the activation of the hall push button or the car push button for one of the floors for causing the elevator car to move to said floor. The retrofit voice actuated system includes at least one voice controller operative for causing the elevator control system to move the elevator car to said floor in response to the voice controller receiving an audio prompt from a user.

### CROSS REFERENCE TO RELATED APPLICATION

This application claims the benefit of U.S. Provisional Patent Application No. 63/056,780, filed Jul. 27, 2020, the contents of which are incorporated herein in its entirety by reference.

### BACKGROUND OF THE INVENTION

### Field of the Invention

The present invention is a computer processor controlled device, a system comprising two or more such devices, and method of use thereof for adding speech recognition and voice control features to an existing elevator control.

### Description of Related Art

Heretofore, control of an elevator was accomplished by a user pressing one or more buttons of a Car Operating Panel (COP) inside of an elevator car (e.g., to cause the elevator car to move to a floor associated with the pressed button) or a Hall Push Button(s) Panel (HPBP), typically mounted on a wall of a floor serviced by the elevator car (e.g., to call the elevator car to the floor). It would, however, be desirable to augment the pressing of said one or more buttons with voice control, e.g., in cases where the user is, for example, carrying an object with both arms and is not readily able to press a button, and/or the user is disabled and has limited or no ability to press a button, and/or the user, over health/contamination concerns, prefers not to touch or press said one or more buttons.

### SUMMARY OF THE INVENTION

Generally, provided, in some non-limiting embodiments or examples, is a computer processor controlled device, a system comprising two or more such devices, and method of use thereof for adding speech recognition and voice control features to an existing elevator control. In some non-limiting embodiments or examples, the device, system and method can work with an existing elevator system, in particular, the buttons of an existing elevator system, does not replace or interfere with the operation an existing elevator control system of the elevator system, and does not require new and/or additional upgrades to the existing elevator system and/or existing elevator control system. Hereinafter, each device that includes speech recognition and voice control features in accordance with the principles of the present invention may sometimes be referred to as a “voice controller”. However, this is not to be construed in a limiting sense.

In some non-limiting embodiments or examples, each voice controller gives elevator passengers or users the option to talk or speak words and/or phrases to control an existing elevator control system to initiate calls without having to push buttons. In some non-limiting embodiments or examples, instances of each voice controller can be connected to the Car Operating Panel (COP) and Hall Push Button(s) Panel (HPBP). In response to one or more voice commands or audio prompts from a user, each voice controller can simulate the pressing of one or more push buttons associated with the COP or HPBP which will then signal the existing elevator control system to control the elevator's movement in the same manner as if a user actually pressed the one or more push buttons.

In some non-limiting embodiments or examples, to simulate the pressing of each push button associated with the elevator, a relay, for example, a solid state relay (transistor) or mechanical relay, can be coupled in parallel with the switching element associated with the push button, whereupon closing of the relay has the same effect on the existing elevator control as the pressing of the push button. In some non-limiting embodiments or examples, each relay can be included as part of the voice controller itself or may be an external relay between the COP or HPBP and the existing elevator control, e.g., the external relay may be a standalone relay or may be part of a higher level controller, such as a PLC or other like controller, that acts as an interface between the COP or HPBP and the existing elevator control. The particular location of each relay, e.g., part of the voice controller itself, separate from the voice controller, or included as part of a higher level controller, e.g., a PLC or other like controller, in communication with the voice controller, is not to be construed in a limiting sense. Herein, and strictly for the purpose of this disclosure, each relay will be described as being part of a voice controller. However, this is not to be construed in a limiting sense.

In some non-limiting embodiments or examples, each voice controller can optionally detect people entering and exiting an elevator utilizing an optional motion sensor. The voice controller can have audio IN and OUT (microphone and speaker). The voice controller can record elevator requests and movements in a computer storage.

In some non-limiting embodiments or examples, an instance of the voice controller can be installed in the elevator car (COP) and at every floor (HPBP) that can be serviced by the elevator car whereupon the elevator car can also be called to a floor using voice commands. Instances of the voice controller installed in the elevator car (COP) and at every floor (HPBP) can be communicatively connected via a wired and/or wireless communication channel.

In some non-limiting embodiments or examples, each instance of the voice controller can be installed inside the elevator shaft with only the microphone, speaker, and optional motion sensor wired and available inside of the elevator car and at each floor using wires/cables mounted in the wall of the elevator car and the wall of each floor.

In some non-limiting embodiments or examples, all the speech recognition and voice commands processing are done in each voice controller itself.

In some non-limiting embodiments or examples, each voice controller can store pre-recorded messages in a memory coupled to the processor and can play the pre-recorded messages to interact with the user. When installed in a hall (HPBP), the voice controller can include relays to simulate the pressing of one or more buttons.

How it Works:

User is at the Hall/Floor Station and Wants to Call the Elevator Car:

In some non-limiting embodiments or examples, a user arrives at a hall station including the HPBP that has associated therewith a first voice controller and speaks, for example, “HEY VATOR”. In another example, the user could speak, for example, the direction they want to go “HEY VATOR GOING UP”, or the floor to which they wish the elevator car to take them “HEY VATOR TAKE ME TO FLOOR 5”, and the like to activate the first voice controller in the hall associated with the HPBP. In this example, the first voice controller may be programmed or configured to monitor via the microphone thereof for the phrase “HEY VATOR” and to respond to this phrase. However, it is envisioned that the first voice controller may be programmed or configured to monitor and respond to other and/or alternative phrases. Accordingly, the description herein of the phrase “HEY VATOR” is not to be construed in a limiting sense,

In an example, if the user did not indicate which direction they would like to go, the first voice controller may respond, via the speaker thereof, “Hi, going up or down?”, or similar. In some non-limiting embodiments or examples, where the HPBP is configured with push buttons for a user to enter a desired floor number where the user wishes the elevator car to take them, the first voice controller may also ask the user to speak the floor number.

In some non-limiting embodiments or examples, the first voice controller can use an optional motion detection sensor of or associated with the first voice controller to detect the presence of a user and, in response to detecting the presence of the user, pronounce a statement or output an audio prompt asking the user which direction or which floor they would like the elevator car to take them. In an example, the user may answer, e.g., “UP”, “DOWN”, or the like, or “FLOOR 5”, whereupon the first voice controller will accept the answer as a command and output a signal that causes, via a relay of or associated with the first voice controller, a simulated pressing of the appropriate Up/Down Push Button of the HPBP. In some non-limiting embodiments or examples, more advanced motion detection and person counter using thermal imaging could also be optionally used to count the number of people inside the elevator car.

When the Elevator Car Arrives:

In some non-limiting embodiments or examples, when the elevator car door(s) open, an optional motion sensor associated with the COP can optionally scan for motion and detect if the user(s) has entered the elevator car whereupon a second voice controller associated with the COP can ask, via a speaker thereof, the user(s) for the destination. In an example, upon entering the elevator car, user(s) will say the floor number(s) where they want to go, and the second voice controller will register each floor number. The second voice controller may be programmed or configured to receive and communicate which floors have been requested and registered as multiple commands that are likely to be issued about the same time. In an example, to register each floor number, the second voice controller can optionally illuminate lights for each floor number on the push button(s) of the COP, and the second voice controller can also output one or more signal(s) that cause, via one or more relays of or associated with the second voice controller, a simulated pressing of one or more of the appropriate floor buttons of the COP. For example, if user(s) says “FLOOR 4” and “FLOOR 5”, the second voice controller causes the relays in parallel with the COP buttons for floors 4 and 5 to activate (e.g., close) thereby simulating the user(s) pressing the buttons for floors 4 and 5.

If there are no more commands from the user(s), the elevator control system will determine when to close the door in its usual manner unless a user issues a close door command to the second voice controller

Further preferred and non-limiting embodiments or examples are set forth in the following numbered clauses

Clause 1: A system for controlling the movement of an elevator car between floors of a multi-floor structure, the system comprising: at least one hall push button on each floor accessible to the elevator car; a car operating panel in the elevator car, the car operating panel including, for each floor, at least one car push button, wherein each push button has a switching element associated with the push button; an elevator control system configured to respond to the activation of the hall push button or the car push button for one of the floors for causing the elevator car to move to said floor; and at least one voice controller configured for causing the elevator control system to move the elevator car to said floor in response to the voice controller receiving a predetermined audio prompt from a user.

Clause 2: The system of clause 1, wherein the voice controller can be operative in parallel with said at least one hall push button.

Clause 3: The system of clause 1 or 2, wherein the voice controller can be operative in parallel with said at least one car push button.

Clause 4: The system of any one of clauses 1-3, wherein the voice controller can include a motion sensor configured to sense motion in the elevator car and, in response to the motion sensor sensing motion in the elevator car, the voice controller can output an audio prompt.

Clause 5: The system of any one of clauses 1-4, wherein: said at least one hall push button can have a first voice controller operative in parallel therewith; and said at least one car push button can have a second voice controller operative in parallel therewith.

Clause 6: The system of any one of clauses 1-5, wherein the first and second voice controllers can be in communication with each other via a communication channel.

Clause 7: The system of any one of clauses 1-6, wherein the communication channel can be a wired communication channel, a wireless communication channel, or a combination of a wired and a wireless communication channel.

Clause 8: The system of any one of clauses 1-7, wherein the voice controller can include a processor and, operatively coupled to said processor, computer memory (RAM, ROM, and/or FLASH MEMORY), a speech processor, a microphone, an audio speaker, and at least one relay coupled in parallel with a switching element of the at least one hall push button or the at least one car push button.

Clause 9: A retrofit voice actuated system configured to be coupled to an existing system for controlling the movement of an elevator car between floors of a multi-floor structure, the existing system comprising at least one hall push button on each floor accessible to the elevator car, a car operating panel in the elevator car, the car operating panel including, for each floor, at least one car push button, wherein each push button has a switching element associated with the push button, and an elevator control system configured to respond to the activation of the hall push button or the car push button for one of the floors for causing the elevator car to move to said floor, wherein the retrofit voice actuated system comprises: at least one voice controller operative for causing the elevator control system to move the elevator car to said floor in response to the voice controller receiving a predetermined audio prompt from a user.

Clause 10: The system of clause 9, wherein the voice controller can be operative in parallel with said at least one hall push button.

Clause 11. The system of clause 9 or 10, wherein the voice controller can be operative in parallel with said at least one car push button.

Clause 12: The system of any one of clauses 9-11, wherein the voice controller can include a motion sensor configured to sense motion in the elevator car and, in response to the motion sensor sensing motion in the elevator car, the voice controller can output an audio prompt.

Clause 13: The system of any one of clauses 9-12, wherein: said at least one hall push button can have a first voice controller operative in parallel therewith; and said at least one car push button can have a second voice controller operative in parallel therewith.

Clause 14: The system of any one of clauses 9-13, wherein the first and second voice controllers can be in communication with each other via a communication channel.

Clause 15: The system of any one of clauses 9-14, wherein the communication channel can be a wired communication channel, a wireless communication channel, or a combination of a wired and a wireless communication channel.

Clause 16: The system of any one of clauses 9-15, wherein the voice controller can include a processor and, operatively coupled to said processor, computer memory (RAM, ROM, and/or FLASH MEMORY), a speech processor, a microphone, an audio speaker, and at least one relay coupled in parallel with a switching element of the at least one hall push button or the at least one car push button.

Clause 17: A method for controlling the movement of an elevator car between floors of a multi-floor structure comprising: (a) receiving from a user by a voice controller a user audio prompt for an elevator car to move to one of the floors; and (b) in response to step (a), converting by the voice controller the audio prompt to a signal that causes a relay in parallel with a switching element associated with a push button of an existing system to activate thereby causing an elevator control system of the existing system to move the elevator car to said floor.

Clause 18: The method of clause 17, wherein the push button can be a hall push button on a floor accessible to the elevator car or a car push button of a car operating panel in the elevator car.

Clause 19: The method of clause 17 or 18 can further include, prior to step (a), in response to a motion sensor sensing motion, the voice controller can output an audio prompt requesting the user to speak the user audio prompt or a different user audio prompt, e.g., a floor number where the user desires the elevator car to take the user.

Clause 20: The method of any one of clauses 17-19, wherein step (a) can include multiple audio prompts from the user and, between at least one pair of user audio prompts, an audio prompt from the voice controller for the user to include in a subsequent user audio prompt specific information.

### BRIEF DESCRIPTION OF THE DRAWING(S)

FIG. 1 is an isolated open view of a non-limiting embodiment or example elevator system;

FIG. 2 is a schematic block diagram of a non-limiting embodiment or example elevator control, in accordance with the principles of the present invention, for controlling the elevator system of FIG. 1;

FIG. 3 is a schematic diagram of a non-limiting embodiment or example car floor push button(s) and car voice controller, in accordance with the principles of the present invention, associated with the COP of the elevator control shown in FIG. 2;

FIG. 4 is a schematic diagram of a non-limiting embodiment or example hall push button(s) and hall voice controller, in accordance with the principles of the present invention, associated with the HPBP of the elevator control shown in FIG. 2; and

FIG. 5 is a flow diagram of a non-limiting embodiment or example method in accordance with the principles of the present invention.

### DESCRIPTION OF THE INVENTION

Various non-limiting examples will now be described with reference to the accompanying figures where like reference numbers correspond to like or functionally equivalent elements.

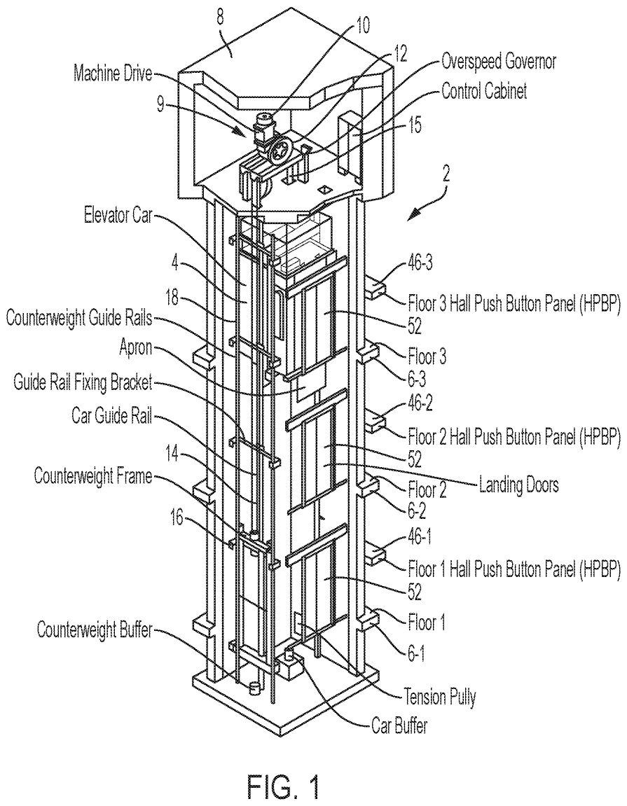

With reference to FIG. 1, in some non-limiting embodiments or examples, an elevator system 2 includes an elevator car 4 that is driven between floors 6-1, 6-2, and 6-3 of a multi-floor structure or building 8 by a drive machine 9 that includes a motor 10 that drives a pulley 12. The elevator car is guided vertically between floors 6 by car guide rails 14 proximate or adjacent the elevator car 4. A cable 15 runs, via pulley 12, between the top of the elevator car 4 and a counterweight frame 16 which is guided vertically between floors 6 by counterweight guide rails 18 that are positioned proximate or adjacent the elevator car 4.

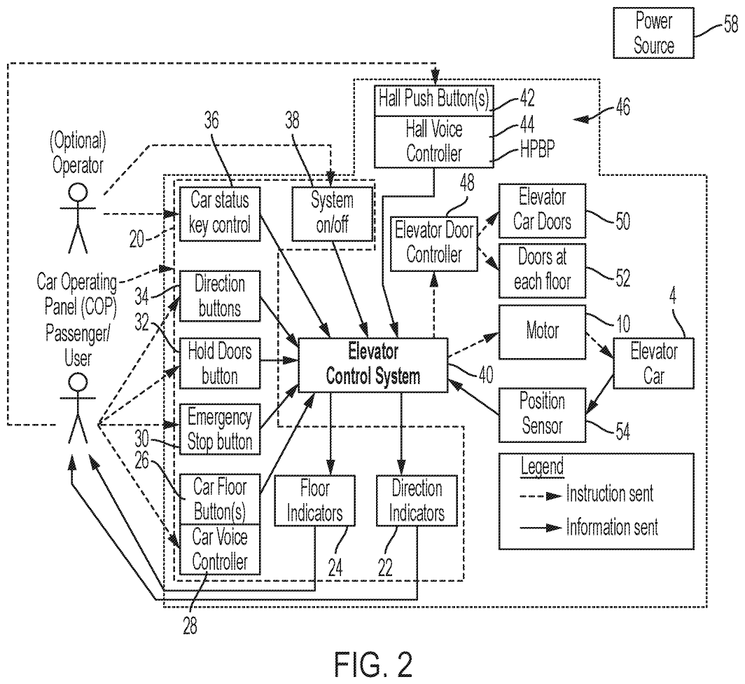

With reference to FIG. 2 and with continuing reference to FIG. 1, in some non-limiting embodiments or examples, the interior of elevator car 4 can include a Car Operating Panel (COP) 20. COP 20 can, in some non-limiting embodiments or examples, include direction indicators 22, floor indicators 24, car floor buttons 26, a car voice controller 28 in accordance with the principles of the present invention, an emergency stop button 30, a hold doors button 32, direction buttons 34, a car status key control 36 and a system on/off control 38.

In this example, car floor buttons 26, emergency stop button 30, hold doors button 32, and direction buttons 34 are input buttons that a passenger/user manually activates in a manner known in the art while in the elevator car 4 to cause an elevator control system 40 to control the corresponding function of the elevator system 2. For example, the user pressing a “1” button of the car floor buttons 26 while the elevator car 4 is on the third floor 6-3 causes the elevator control system 40 to power motor 10 in a way that causes pulley 12 to rotate and lower elevator car 4 to the first floor 6-1.

Elevator control system 40 also receives input from one or more Hall Push Button Panel(s) (HPBP) 46 each of which includes hall push buttons 42 and a hall voice controller 44 in accordance with the principles of the present invention. Each HPBP 46-1, 46-2, and 46-3 shown in FIG. 1 can be mounted on the walls of floors 6-1, 6-2, and 6-3, respectively, of building 8. While FIG. 2 shows only a single HPBP 46 connected to provide information to elevator control system 40, it is to be understood that this illustration is exemplary and strictly for the purpose of simplicity and that each HPBP 46-1, 46-2, and 46-3 in FIG. 1 is connected to elevator control system 40 like HPBP 46 in FIG. 2 to provide information to elevator control system 40.

Hall push buttons 42 are input buttons that a passenger/user manually activates in a manner known in the art while on a floor 6 of building 8 outside of elevator car 4 to cause elevator control system 40 to control the corresponding function of the elevator system 2. For example, starting with elevator car 4 on the third floor 6-3, a user on the first floor 6-1 pressing an UP arrow or a call button of HPBP 46 causes the elevator control system 40 to power motor 10 in a way that causes pulley 12 to rotate and lower elevator car 4 to the first floor 6-1.

Except for the car voice controller 28 and the hall voice controller 44, the elements shown in FIGS. 1 and 2 described above and further including, as shown in FIG. 2, the elevator door controller 48, the elevator car doors 50, the doors at each floor 52, and the position sensor 54 are known in the art and, for the sake of simplicity, will not be discussed further herein except as may be needed for an understanding of the present invention.

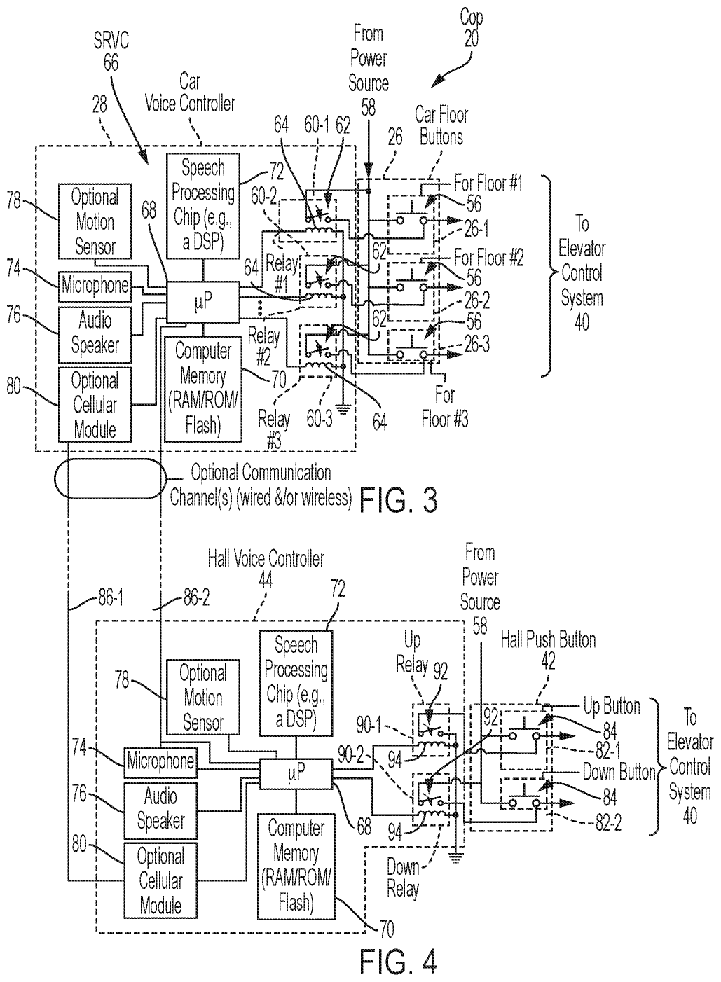

With reference to FIG. 3 and with continuing reference to all previous figures, in some non-limiting embodiments or examples, car floor buttons 26 can include N buttons, where N equals at least the number of floors 6 of building 8 to be serviced by elevator system 2. In an example, car floor buttons 26 can include buttons 26-1, 26-2, and 26-3 corresponding to the three floors 6-1, 6-2, and 6-3 of building 8 shown in FIG. 1

Each car floor button 26 can include a manually actuated switching element 56 that can be in a normally open state when the car floor button 26 is not manually actuated by the user and which can be in a closed state when the car floor button 26 is manually actuated by the user. When the car floor button 26 is manually actuated by the user to its closed state, an electrical potential (e.g., power or ground) is provided via the switching element 56 of the button from a power source 58 to a corresponding input of elevator control system 40 which, in response, causes, among other things, the elevator car 8 to travel to the floor associated with the user actuated car floor button 26 in a manner known in the art.

In an example, all control and movement of elevator car 4, the opening/closing of elevator car doors 50 and the doors at each floor 52, and the control of all other operations associated with the movement of elevator car 4 and the transport of user(s) between floors by elevator car 4 is controlled by elevator control system 40 in a manner know in the art in accordance with the design and/or programming of elevator control system 40.

In an example, starting with elevator car 8 at the third floor 6-3, actuating car floor button 26-1 corresponding to the first floor 6-1 causes the elevator control system 40 to control motor 10 in a way that causes pulley 12 to rotate and move (or lower) elevator car 4 to the first floor 6-1. In another example, the user actuating car floor button 26-2 corresponding to the second floor 6-2 causes the elevator control system 40 to control motor 10 in a way that causes pulley 12 to rotate and move (or lower) the elevator car 4 to the second floor 6-2.

In another example, starting with elevator car 8 on the first floor 6-1, actuating car floor button 26-3 corresponding to the third floor 6-3 causes the elevator control system 40 to control motor 10 in a way that causes pulley 12 to rotate and move (or raise) elevator car 4 to the third floor 6-3. Similarly, the user actuating car floor button 26-2 corresponding to the second floor 6-2 causes the elevator control system 40 to control motor 10 in a way that causes pulley 12 to rotate and move (or raise) the elevator car 4 to the second floor 6-2. The foregoing description of elevator control system 40 responding to the user actuating car floor buttons 26 is known in the art.

In order to augment the user pressing car floor buttons 26 with voice control, the car voice controller 28 in accordance with the principles of the present invention can be provided. In some non-limiting embodiments or examples, the car voice controller 28 includes relays 60, e.g., relays 60-1, 60-2, and 60-3, connected in parallel with the switching element 56 of each car floor button 26, e.g., car floor button 26-1, 26-2, and 26-3. More specifically, each relay 60 includes a switching element 62 that is connected in parallel with the switching element 56 of one of the car floor buttons 26. For example, the switching element 62 of relay 60-1 is connected in parallel with the switching element 56 of car floor button 26-1; the switching element 62 of relay 60-2 is connected in parallel with the switching element 56 of car floor button 26-2; and the switching element 62 of relay 60-3 is connected in parallel with the switching element 56 of car floor button 26-3.

Each relay 60 includes switching element 62 that can be in a normally open state when the relay 60 is not actuated and can be in a closed state when the relay 60 is actuated by energizing a coil 64 of said relay in a manner described hereinafter. When a relay 60 is actuated, e.g., by energizing the coil 64 of said relay, the switching element 62 moves from its open state to its closed state and electrical potential (e.g., power or ground) is provided from power source 58 via said switching element 62 to the elevator control system 40 which, in response, causes, among other things, the elevator car 8 to travel to the floor associated with the relay 60.

For example, starting with elevator car 8 at the third floor 6-3, actuating relay 60-1 corresponding to the first floor 6-1 causes the elevator control system 40 to control motor 10 in a way that causes pulley 12 to rotate and move (or lower) elevator car 4 to the first floor 6-1. In another example, the user actuating relay 60-2 corresponding to the second floor 6-2 causes the elevator control system 40 to control motor 10 in a way that causes pulley 12 to rotate and move (or lower) the elevator car 4 to the second floor 6-2.

In another example, starting with elevator car 8 on the first floor 6-1, actuating relay 60-3 corresponding to the third floor 6-3 causes the elevator control system 40 to control motor 10 in a way that causes pulley 12 to rotate and move (or raise) elevator car 4 to the third floor 6-3. Similarly, the user actuating relay 62-2 corresponding to the second floor 6-2 causes the elevator control system 40 to control motor 10 in a way that causes pulley 12 to rotate and move (or raise) the elevator car 4 to the second floor 6-2.

In some non-limiting embodiments or examples, the state of each relay 60 of car voice controller 28 can be controlled by a speech recognition voice controller (SRVC) 66 of car voice controller 28. SRVC 66 includes a microprocessor 68 running under the control of a non-transitory computer program stored in a computer memory 70, e.g., stored in ROM or FLASH memory. Computer memory 70 can also include working memory, e.g., RAM, that microprocessor 68 uses in a manner known in the art for processing operations. SRVC 66 also includes a microphone 74 that can convert analog audio received by microphone 74 into an analog electrical signal that microprocessor 68 (i.e., an analog-to-digital converter (ADC) of microprocessor 68) can convert into digital data that can be processed by a speech processing chip 72 and converted into a digital command that microprocessor 68 can use to selectively energize (or not energize) one or more coils 64 of relays 60-1, 60-2, and 60-3 thereby selectively controlling the state of one or more of the switching elements 62 of relays 60-1, 60-2, and 60-3.

Non-limiting embodiments or examples of the operation of SRVC 66 controlling the state of the switching element 62 of relay 60-1 will now be described. However, this is not to be construed in a limiting sense since it is envisioned that the state of the switching element 62 of each relay 60-2 and 60-3 can be controlled in a similar manner based on instructions spoken by the user.

In an example, starting with the elevator car 4 at the third floor 6-3, a user entering elevator car 4 speaks “HEY VATOR TAKE ME TO FLOOR 1” or “FIRST FLOOR”. This speech is converted by microphone 74 into an analog electrical signal which is provided to microprocessor 68 which digitizes the analog electrical signal and provides the digitized analog electrical signal to speech processing chip 72. Speech processing chip 72 converts the digitized analog electrical signal into a digital command signal that microprocessor 68 uses to energize coil 64 of relay 60-1 associated with the first floor 6-1. In response to energizing coil 64 of relay 60-1, the switching element 62 of relay 60-1 changes from its open state to its closed state thereby connecting the electrical potential (e.g., power or ground) of power source 58 to the elevator control system 40. In response to this connection of power source 58 to the elevator control system 40 via relay 60-1, the elevator control system 40 controls the operation of motor 10 in a way that causes pulley 12 to rotate and lower elevator car 4 to the first floor 6-1, i.e., the elevator control system 40 controls the operation of motor 10 in the same manner as though the user had pressed car floor button 26-1. In an example, this movement of elevator car 4 in response to energizing coil 64 of relay 60-1 and any related actions, such as the opening/closing of elevator car doors 50 and the doors 52 on the first floor 6-1, can be controlled by elevator control system 40 in a manner known in the art in accordance with the design and/or programming of elevator control system 40.

At a suitable time after elevator control system 40 has responded to the electrical potential (e.g., power or ground) of power source 58 being provided to the elevator control system 40, microprocessor 68 can de-energize coil 64 of relay 60-1 whereupon the switching element 62 of relay 60-1 returns to its open state.

SRVC 66 can also include an audio speaker 76, an optional motion sensor 78, and an optional cellular communication module 80. In an example, motion sensor 78 and audio speaker 76 can be used by the SRVC to prompt or query the user. For example, upon detecting the user entering the elevator car 4 located, for example, at the third floor 6-3, the motion sensor 78 can send to the microprocessor 68 a signal indicating motion detected in the elevator car 4. In response, the combination of the microprocessor 68 and the speech processing chip 72 can generate an audio prompt or query that is output via the audio speaker 76 to the user. In an example, the audio prompt or query output via the audio speaker 76 may be “HELLO, WHAT FLOOR WOULD YOU LIKE TO GO?” In response to this audio prompt or query, the user may reply by speaking “FIRST FLOOR”. This speech can be converted into a digital command signal in the manner described above that microprocessor 68 uses to energize coil 64 of relay 60-1 associated with the first floor 6-1. In response to energizing coil 64 of relay 60-1, the switching element 62 of relay 60-1 changes from its open state to its closed state thereby connecting the electrical potential (e.g., power or ground) of power source 58 to the elevator control system 40. In response to this connection of power source 58 to the elevator control system 40 via relay 60-1, and elevator control system 40 controls the operation of motor 10 in a way that causes pulley 12 to rotate and lower elevator car 4 to the first floor 6-1, i.e., elevator control system 40 controls the operation of motor 10 in the same manner as though the user had pressed car floor button 26-1. In an example, this movement of elevator car 4 in response to energizing coil 64 of relay 60-1 and any related actions, such as the opening/closing of elevator car doors 50 and the doors 52 on the first floor 6-1, can be controlled by elevator control system 40 in a manner know in the art in accordance with the design and/or programming of elevator control system 40.

At a suitable time after elevator control system 40 has responded to the electrical potential (e.g., power or ground) of power source 58 being provided to the elevator control system 40, microprocessor 68 can de-energize coil 64 of relay 60-1 whereupon the switching element 62 of relay 60-1 returns to its open state.

Audio speaker 76 can also be used without optional motion sensor 78 to prompt or query the user. For example, if upon entering the elevator car 4 located, for example, at the third floor 6-3, the user speaks “HEY VATOR”, the combination of the microprocessor 68 and the speech processing chip 72 can process this speech in the manner described above and, in response, can cause the audio speaker 76 to output a prompt such as, for example, “HELLO, WHAT FLOOR WOULD YOU LIKE TO GO?”. In reply, the user may reply by speaking “FIRST FLOOR”. This speech can be converted into a digital command signal in the manner described above that is used to cause the switching element 62 of relay 60-1 to change from its open state to its closed state thereby connecting the electrical potential (e.g., power or ground) of power source 58 to the elevator control system 40. In response to this connection of power source 58 to the elevator control system 40 via relay 60-1, the elevator control system 40 controls the operation of motor 10 in a way that causes pulley 12 to rotate and lower elevator car 4 to the first floor 6-1, i.e., elevator control system 40 controls the operation of motor 10 in the same manner as though the user had pressed car floor button 26-1. In an example, this movement of elevator car 4 in response to energizing coil 64 of relay 60-1 and any related actions, such as the opening/closing of elevator car doors 50 and the doors 52 on the first floor 6-1, can be controlled by elevator control system 40 in a manner know in the art in accordance with the design and/or programming of elevator control system 40.

In the manner described above, at an suitable time, coil 64 of relay 60-1 can be de-energized whereupon the switching element 62 of relay 60-1 returns to its open state.

In a similar manner, the state of the switching element 62 of relay 60-2 can be controlled based on instructions spoken by the user, e.g., “HEY VATOR TAKE ME TO FLOOR 2” or “SECOND FLOOR” and/or the state of the switching element 62 of relay 60-3 can be controlled based on instructions spoken by the user, e.g., “HEY VATOR TAKE ME TO FLOOR 3” or “THIRD FLOOR”. In an example, the movement of elevator car 4 in response to energizing the coil(s) 64 of relay 60-2 and/or relay 60-3 and any related actions, such as the opening/closing of elevator car doors 50 and the doors 52 on the second floor 6-2 and/or third floor 6-3, can be controlled by elevator control system 40 in a manner know in the art in accordance with the design and/or programming of elevator control system 40.

As can be understood from the foregoing, moving the switching element 62 of each relay 60-1, 60-2, and 60-3 to its closed state has the same effect on the operation of elevator system 2 as the user pressing or actuating the respective car floor buttons 26-1, 26-2, and 26-3.

With reference to FIG. 4 and with continuing reference to all previous figures, in some non-limiting embodiments or examples, each HPBP 46 includes hall push buttons 42 and a hall voice controller 44. In an example, hall push buttons 42 can include an UP push button 82-1 and a DOWN push button 82-2. However, it is envisioned that hall push buttons 42 may only include a single CALL push button.

Each push button 82 can include a manually actuated switching element 84 that can be in a normally open state when the push button 82 is not manually actuated by the user and which can be in a closed state when the push button 82 is manually actuated by the user. When the push button 82 is manually actuated by the user to its closed state, an electrical potential (e.g., power or ground) is provided via the switching element 84 of the actuated push button 82 from the power source 58 to the elevator control system 40 which, in response, causes, among other things, the elevator car 4 to travel to the floor associated with the hall push buttons 42 that includes the actuated push button and opens the elevator car doors and the doors of the elevator system 2 located at said floor.

In an example, this movement of elevator car 4 and any related actions, such as the opening/closing of elevator car doors 50 and the doors 52 on a floor, can be controlled by elevator control system 40 in a manner know in the art in accordance with the design and/or programming of elevator control system 40. The operation and control logic of elevator control system 40 controlling the movement of elevator car 4, the open/close operation of the elevator car doors and the open/close operation of the doors of each floor where the elevator car 4 stops in response to actuating the UP push button 82-1 or the DOWN push button 82-2 is known in the art and will not be described further in detail herein for the purpose of simplicity.

In order to augment the user pressing hall push buttons 42 with voice control, the hall voice controller 44 in accordance with the principles of the present invention may be provided. In some non-limiting embodiments or examples, the hall voice controller 44 includes relays 90, e.g., UP relay 90-1 and DOWN relay 90-2, connected in parallel with the switching element 84 of each hall push button 26. More specifically, each relay 90 includes a switching element 92 that is connected in parallel with the switching element 84 of one of the hall push buttons 26. For example, the switching element 92 of UP relay 90-1 is connected in parallel with the switching element 84 of UP push button 82-1 and the switching element 92 of DOWN relay 90-2 is connected in parallel with the switching element 84 of DOWN push button 82-2.

Each relay 90 includes switching element 92 that can be in an normally open state when the relay 90 is not actuated and can be in a closed state when the relay 90 is actuated by energizing a coil 94 of said relay in a manner described hereinafter. When a relay 90 is actuated, e.g., by energizing the coil 94 of said relay, the switching element 92 moves from its open state to its closed state whereupon an electrical potential (e.g., power or ground) is provided from power source 58 via the switching element 92 to the elevator control system 40 which, in response, controls, among other things, the movement of elevator car 8 in a manner known in the art.

In some non-limiting embodiments or examples, that state of each relay 90 of hall voice controller 44 can be controlled by a speech recognition voice controller (SRVC) 96 of hall voice controller 44 in the same manner as the state of each relay 60 of car voice controller 28 is controlled by the SRVC 66 of car voice controller 28 in the manner described above. In some non-limiting embodiments or examples, and for the purpose of describing the operation of SRVC 96, it will be assumed that the elements comprising SRVC 96 and their operation are similar to the elements comprising SRVC 66 and their operation. Accordingly, in FIG. 4, the same reference numbers are utilized for the elements of SRVC 96 as were used for the elements of SRVC 66 in FIG. 3. However, this is not to be construed in a limiting sense since it is envisioned that the elements comprising SRVC 96 may be different than the elements comprising SRVC 66. Because the elements comprising SRVC 96 and their operation are (for the purpose of this description) similar to the elements comprising SRVC 66 and their operation, a detailed description of the operation of the elements comprising SRVC 96 when interacting with a user will not be provided herein to avoid unnecessary redundancy.

As shown in FIG. 4, in SRVC 96, microprocessor 68 is separately connected to the coils 94 of UP relay 90-1 and DOWN relay 90-2. An exemplary interaction between a user and hall voice controller 44 will now be described.

In an example, a user arriving at a HPBP 46 that includes hall voice controller 44 including SRVC 96 speaks, for example, “HEY VATOR GOING UP”. In response to this speech, the microprocessor 68 of SRVC 96 energizes the coil 94 of UP relay 90-1 whereupon the switching element 92 of UP relay 90-1 changes from its open state to its closed state thereby connecting the electrical potential (e.g., power or ground) of power source 58 to the elevator control system 40. In response to this connection of power source 58 to the elevator control system 40 via the switching element 92 of UP relay 90-1, the elevator control system 40 causes, among other things, the elevator car 4 to travel to the floor associated with the HPBP 46 and opens the elevator car doors and the doors located at said floor in the same manner as though the user pressed UP button 82-1. Thereafter, the movement of elevator car 4 is controlled by the elevator control system 40 in a manner know in the art in accordance with the design and/or programming of elevator control system 40 and the interaction with elevator control system 40 by the user via COP 20 and/or HPBP 46.

At a suitable time after elevator control system 40 has responded to the electrical potential (e.g., power or ground) of power source 58 being provided to the elevator control system 40, microprocessor 68 can de-energize coil 94 of UP relay 90-1 whereupon the switching element 92 of UP relay 90-1 returns to its open state.

In another example, a user arriving at a HPBP 46 that includes hall voice controller 44 including SRVC 96 speaks, for example, “HEY VATOR GOING DOWN”. In response to this speech, the microprocessor 68 of SRVC 96 energizes the coil 94 of DOWN relay 90-2 whereupon the switching element 92 of DOWN relay 90-2 changes from its open state to its closed state thereby connecting the electrical potential (e.g., power or ground) of power source 58 to the elevator control system 40. In response to this connection of power source 58 to the elevator control system 40 via the switching element 92 of DOWN relay 90-2, the elevator control system 40 causes, among other things, the elevator car 4 to travel to the floor associated with the HPBP 46 and opens the elevator car doors and the doors of the elevator system 2 located at said floor in the same manner as though the user pressed DOWN button 82-2. Thereafter, the movement of elevator car 4 is controlled by elevator control system 40 in a manner know in the art in accordance with the design and/or programming of elevator control system 40 and the interaction with elevator control system 40 by the user via COP 20 and/or HPBP 46.

At a suitable time after elevator control system 40 has responded to the electrical potential (e.g., power or ground) of power source 58 being provided to the elevator control system 40, microprocessor 68 can de-energize coil 94 of DOWN relay 90-2 whereupon the switching element 92 of DOWN relay 90-2 returns to its open state.

As can be understood from the foregoing, actuating the switching element 92 of UP relay 90-1 and DOWN relay 90-2 has the same effect on the operation of elevator system 2 as the user pressing or actuating the respective UP push button 82-1 and DOWN push button 82-2.

With specific reference to FIGS. 3-4, in some non-limiting embodiments or examples, the optional cellular modules 80 of the car voice controller 28 and the hall voice controller 44 may be provided to facilitate a wireless communication channel 86-1 between the car voice controller 28 and the hall voice controller 44. In an example, such wireless communication channel 86-2 may be utilized for coordinating the operations of the car voice controller 28 and the hall voice controller 44. In another example, each optional cellular module 80, when provided, may be utilized for updating the non-transitory computer program (firmware) stored in a computer memory(s) 70 of the corresponding voice controller 28 and/or 44.

Also or alternatively, in some non-limiting embodiments or examples, an optional wired and/or wireless communication channel 86-2, that may not require the use of optional cellular modules 80, may be provided between the microprocessors 68 of the car voice controller 28 and the hall voice controller 44 for the purpose of coordinating the operations of the car voice controller 28 and the hall voice controller 44 and/or for the purpose of updating non-transitory computer program (firmware) stored in a computer memory(s) 70 of the corresponding voice controller 28 and/or 44.

Finally, while the present invention has been described as having separate car voice controller 28 and hall voice controller 44, this is not to be construed in a limiting sense since it envisioned that the functions of and operations provided by car voice controller 28 and hall voice controller 44 may be provided by and incorporated into a single voice controller that is similar to voice controller 28 or 44. In some non-limiting embodiments or examples of such single voice controller, the microprocessor 68 thereof may be connected to all of the car floor buttons 26, the UP push button 82-1, the DOWN push button 82-2, the coils 64 of relays 60-1, 60-2, and 60-3 and to the coils 94 of UP relay 90-1 and DOWN relay 90-1, whereupon said microprocessor 68 can respond to the actuation of any car floor buttons 26, the UP push button 82-1, and the DOWN push button 82-2 in the manner described above and can individually control the state of the switching elements 62 and 92 in response to a user speaking in the manner described above.

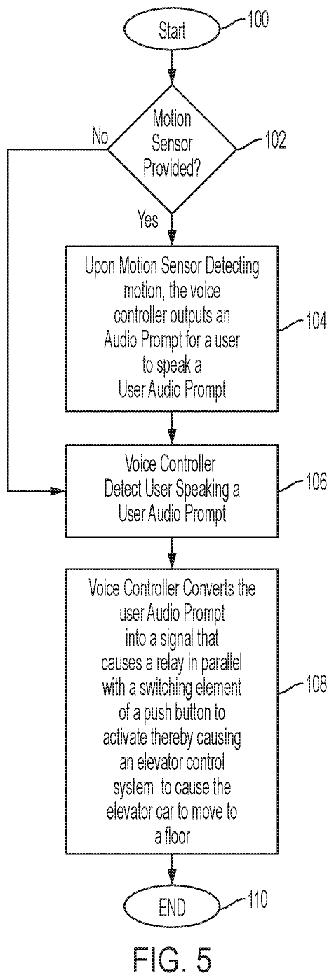

With reference to FIG. 5, an exemplary flow diagram of a method in accordance with the present invention is illustrated. The method begins by advancing from start step 100 to step 102 wherein it is decided if a voice controller, e.g., car voice controller 28 or hall voice controller 44, includes an optional motion sensor, e.g., motion sensor 78 of car voice controller 28 or motion sensor 78 of hall voice controller 44. If so, the method advances to step 104 wherein, upon the motion sensor detecting motion, the voice controller outputs an audio prompt for a user to speak a user audio prompt. The method then advances to step 106. However, if the method determines in step 102 that the voice controller does not include an optional motion sensor, the method then advances from step 102 directly to step 106

In step 106, the voice controller detects the user speaking the requested user audio prompt. In step 108, the voice controller converts the detected user audio prompt into a signal that can be used to cause the elevator control system 40 to move the elevator car 4 to one of the floors 6. Thereafter, the method advances to stop step 110.

As can be seen, the present invention is a system for controlling the movement of an elevator car between floors of a multi-floor structure. The system includes at least one hall push button on each floor accessible to the elevator car; a car operating panel in the elevator car, the car operating panel including, for each floor, at least one car push button, wherein each push button has a switching element associated with the push button; an elevator control system configured to respond to the activation of the hall push button or the car push button for one of the floors for causing the elevator car to move to said floor; and at least one voice controller configured for causing the elevator control system to move the elevator car to said floor in response to the voice controller receiving a predetermined audio prompt from a user.

The invention is also a retrofit voice actuated system configured to be coupled to an existing system for controlling the movement of an elevator car between floors of a multi-floor structure, the existing system comprising at least one hall push button on each floor accessible to the elevator car, a car operating panel in the elevator car, the car operating panel including, for each floor, at least one car push button, wherein each push button has a switching element associated with the push button, and an elevator control system configured to respond to the activation of the hall push button or the car push button for one of the floors for causing the elevator car to move to said floor, wherein the retrofit voice actuated system comprises at least one voice controller operative for causing the elevator control system to move the elevator car to said floor in response to the voice controller receiving a predetermined audio prompt from a user.

Finally, the invention is also a method for controlling the movement of an elevator car between floors of a multi-floor structure comprising: (a) receiving by a voice controller from a user a user audio prompt for an elevator car to move to one of the floors; and (b) in response to step (a), converting by the voice controller the user audio prompt to a signal that causes a relay in parallel with a switching element associated with a push button of an existing system to activate thereby causing an elevator control system of the existing system to move the elevator car to said floor.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A system for controlling the movement of an elevator car between floors of a multi-floor structure, the system comprising:
at least one hall push button on each floor accessible to the elevator car;
a car operating panel in the elevator car, the car operating panel including, for each floor, at least one car push button, wherein each push button has a switching element associated with the push button;
an elevator control system configured to respond to the activation of the hall push button or the car push button for one of the floors for causing the elevator car to move to said floor; and
at least one voice controller configured for causing the elevator control system to move the elevator car to said floor in response to the voice controller receiving a predetermined audio prompt from a user.

2. The system of claim 1, wherein the voice controller is operative in parallel with said at least one hall push button.

3. The system of claim 1, wherein the voice controller is operative in parallel with said at least one car push button.

4. The system of claim 3, wherein the voice controller includes a motion sensor configured to sense motion in the elevator car and, in response to the motion sensor sensing motion in the elevator car, the voice controller outputting an audio prompt.

5. The system of claim 1, wherein:
said at least one hall push button has a first voice controller operative in parallel therewith; and
said at least one car push button has a second voice controller operative in parallel therewith.

6. The system of claim 5, wherein the first and second voice controllers are in communication with each other via a communication channel.

7. The system of claim 6, wherein the communication channel is wired, wireless, or a combination of wired and wireless.

8. The system of claim 1, wherein the voice controller includes a processor and, operatively coupled to said processor, computer memory (RAM, ROM, and/or FLASH MEMORY), a speech processor, a microphone, an audio speaker, and at least one relay coupled in parallel with a switching element of the at least one hall push button or the at least one car push button.

9. A retrofit voice actuated system configured to be coupled to an existing system for controlling the movement of an elevator car between floors of a multi-floor structure, the existing system comprising at least one hall push button on each floor accessible to the elevator car, a car operating panel in the elevator car, the car operating panel including, for each floor, at least one car push button, wherein each push button has a switching element associated with the push button, and an elevator control system configured to respond to the activation of the hall push button or the car push button for one of the floors for causing the elevator car to move to said floor, wherein the retrofit voice actuated system comprises:
at least one voice controller operative for causing the elevator control system to move the elevator car to said floor in response to the voice controller receiving a predetermined audio prompt from a user.

10. The system of claim 9, wherein the voice controller is operative in parallel with said at least one hall push button.

11. The system of claim 9, wherein the voice controller is operative in parallel with said at least one car push button.

12. The system of claim 9, wherein the voice controller includes a motion sensor configured to sense motion in the elevator car and, in response to the motion sensor sensing motion in the elevator car, the voice controller outputting an audio prompt.

13. The system of claim 9, wherein:
said at least one hall push button has a first voice controller operative in parallel therewith; and
said at least one car push button has a second voice controller operative in parallel therewith.

14. The system of claim 13, wherein the first and second voice controllers are in communication with each other via a communication channel.

15. The system of claim 14, wherein the communication channel is wired, wireless, or a combination of wired and wireless.

16. The system of claim 9, wherein the voice controller includes a processor and, operatively coupled to said processor, computer memory (RAM, ROM, and/or FLASH MEMORY), a speech processor, a microphone, an audio speaker, and at least one relay coupled in parallel with a switching element of the at least one hall push button or the at least one car push button.

17. A method for controlling the movement of an elevator car between floors of a multi-floor structure comprising:
(a) receiving by a voice controller from a user a user audio prompt for an elevator car to move to one of the floors; and
(b) in response to step (a), converting by the voice controller the user audio prompt to a signal that causes a relay in parallel with a switching element associated with a push button of an existing system to activate thereby causing an elevator control system of the existing system to move the elevator car to said floor.

18. The method of claim 17, wherein the push button is a hall push button on a floor accessible to the elevator car or a car push button of a car operating panel in the elevator car.

19. The method of claim 17, further including, prior to step (a), in response to a motion sensor sensing motion, the voice controller outputting an audio prompt requesting the user to speak the user audio prompt.

20. The method of claim 17, wherein step (a) includes multiple audio prompts from the user and, between at least one pair of user audio prompts, an audio prompt from the voice controller for the user to include in a subsequent user audio prompt specific information.
